(19) United States
(12) Patent Application Publication
(10) Pub. No.: US 2006/0143397 A1
(43) Pub. Date: Jun. 29, 2006

(54) Dirty line hint array for cache flushing

(76) Inventors: R. Frank O'Bleness, Tempe, AZ (US); Sujat Jamil, Austin, TX (US); Quinn W. Merrell, Phoenix, AZ (US); Hang T. Nguyen, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,637

(22) Filed: Dec. 29, 2004

(51) Int. Cl. G06F 13/28

(52) U.S. Cl. 711/135

(57) ABSTRACT

Techniques for using a dirty line hint array when flushing a cache are disclosed. In one embodiment, an apparatus includes a number of hint bits. Each hint bit corresponds to a number of cache lines, and indicates whether at least one of those cache lines is dirty.

### BACKGROUND

1. Field

The present disclosure pertains to the field of caching in data processing apparatuses, and, more specifically, to the field of cache flushing.

2. Description of Related Art

The maintenance of a cache memory in a data processing apparatus, particularly multiprocessor systems, includes flushing the cache from time to time. A typical cache includes one dirty bit per line to indicate whether the information in the cache line was modified while in the cache. A cache flush may be performed with a software routine that includes checking the dirty bit for every line in the cache and writing the lines that are dirty back to memory.

### BRIEF DESCRIPTION OF THE FIGURES

The present invention is illustrated by way of example and not limitation in the accompanying figures.

FIG. 1 illustrates an embodiment of a cache and a dirty line hint array.

FIG. 2 illustrates an embodiment of a method for using a dirty line hint array when flushing a cache.

FIG. 3 illustrates an embodiment of a system in which a dirty line hint array may be used when flushing a cache.

### DETAILED DESCRIPTION

The following description describes embodiments of techniques for using a dirty line hit array when flushing a cache. In the following description, numerous specific details, such as logic and circuit configurations, may be forth in order to provide a more thorough understanding of the present invention. It will be appreciated, however, by one skilled in the art, that the invention may be practiced without such specific details. Additionally, some well known structures, circuits, and the like have not been shown in detail, to avoid unnecessarily obscuring the present invention.

Embodiments of the present invention provide techniques for using a dirty line hit array when flushing a cache, and may be applied to any cache, regardless of size, level of set associativity, level in the memory hierarchy, or other attributes. These techniques may be used when flushing a cache for any purpose, including flushing shared caches in multiprocessor systems and flushing caches before entering a sleep or other low power mode.

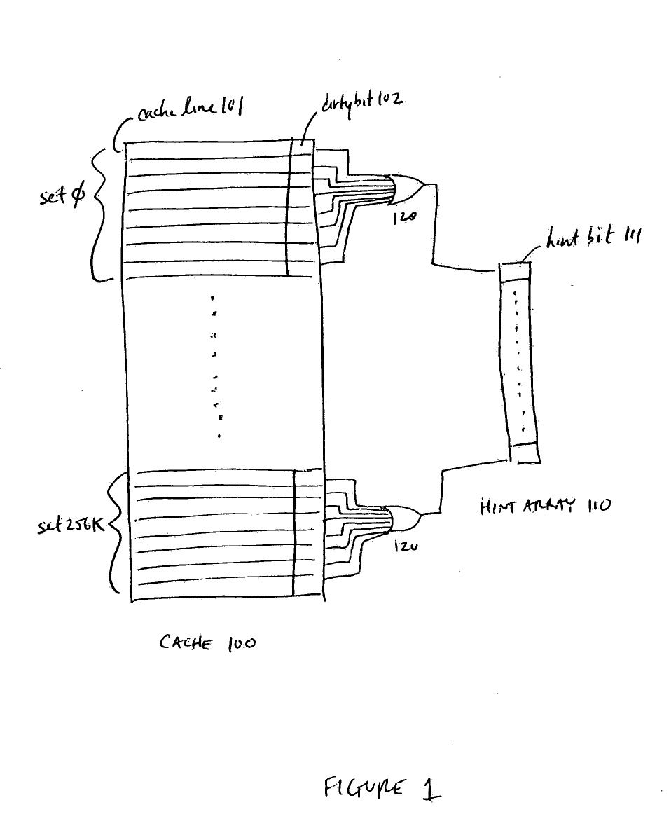

FIG. 1 illustrates an embodiment of cache 100 and hint array 110 in accordance with the present invention. In this embodiment, cache 100 is an eight way set associative cache having 2M cache lines 101 and one dirty bit 102 per line. Hint array 110 is a memory array having a total of 256K “hint” bits 111, each hint bit 111 being mapped to one of the 256K sets in cache 100. A hint bit 111 is set if any of the eight dirty bits 102 in the corresponding set is set. Hint array 110 may be implemented with any known memory elements in any known arrangement.

The embodiment of FIG. 1 shows the mapping of a set of cache 100 to a hint bit 111 as an OR gate 120 with all of the dirty bits 102 in the set as inputs and corresponding hint bit 111 as the output. A set of cache 100 may be mapped to a hint bit 111 according to any approach, including as physically or logically illustrated in FIG. 1, or any known addressing or indexing approach. An approach such as an addressing or indexing approach may include setting a hint bit 111 to dirty whenever a corresponding cache line 101 is changed.

When cache 100 is flushed, before a dirty bit 102 is checked to determine whether the corresponding cache line 101 must be written back to memory, the hint bit 111 for the set to which the cache line 101 belongs is read. If the hint bit 1111 is set, then at least one of the cache lines 101 in that set must be dirty. Therefore, the dirty bit 102 is checked and the cache flush continues as normal. However, if the hint bit 111 is not set, then every cache line 101 in that set must be clean, so there is no need to check the dirty bit 102. Accordingly, the time and power required to check the dirty bit 111 may be saved.

Furthermore, the hint bit 111 corresponding to a given set, or any other segment, section, or partition, may be read to potentially eliminate other cache accesses during the flush. For example, a hint bit 111 may be read before accessing a cache to determine if there is a hit to a designated address for a possible writeback. If the hint bit 111 is read as clean, then no cache access is needed to determine if the cache line corresponding to the designated address is present and valid.

In other embodiments, a hint bit in a hint array may correspond to any number of dirty bits in a cache. For example, a hint array may have 512K hint bits, one for each of 512K sets in a four-way set associative cache having 2M lines. In this configuration, there are four dirty bits per hint bit. Alternatively, a hint array may have 32K hint bits, and an eight-way set associative cache may be logically divided into 32K segments, where each hint bit corresponds to one segment of eight of the 256K sets in an eight-way set associative cache having 2M lines. In this configuration, there are 64 dirty bits per hint bit. The number of dirty bits per hint bit and the size and configuration of the hint array may be chosen based on any considerations, such as to provide a short enough access time such that the hit bit lookup may be used to gate the cache access.

Maintaining a hint array may include clearing a hint bit whenever a cache flush routine completes looping through all of the memory addresses or cache lines that may be mapped to the hint bit.

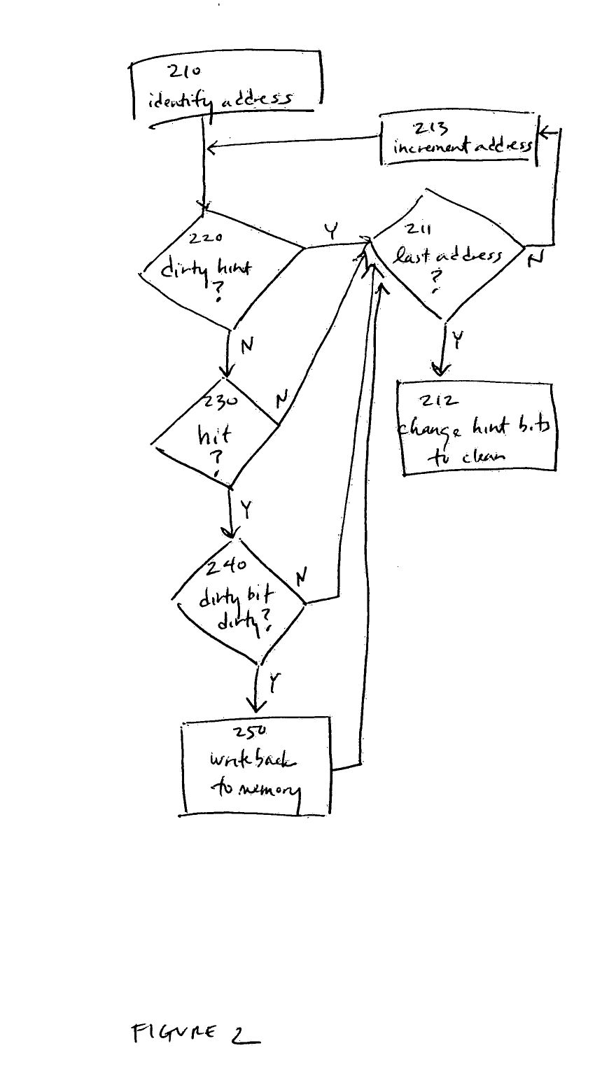

FIG. 2 is a flowchart illustrating an embodiment of a method for using a dirty line hint array when flushing a cache. In block 210, the flush routine identifies an address to be checked to see if a cache line writeback is required. In block 220, the hint bit for the cache set, or any other segment, section, or partition, to which the cache line belongs is read from the hint array. If the hint bit is read as clean, then, in block 211, if the address is the last address to be checked, then, in block 212, any dirty hint bits in the hint array are changed to clean. Otherwise, the address is incremented in block 213, and flow returns to block 220.

However, if the hint bit is read as dirty, then, in block 230, the cache is accessed to determine if the designated line is present and valid in the cache. If it is not, then flow proceeds to block 211 as described above. However, if the designated line is present and valid, then, in block 240, the dirty bit for that cache line is read. If the dirty bit is read as clean, then flow proceeds to block 211 as described above. However, if the dirty bit is read as clean, then, in block 250, the cache line is written back to memory. Then flow proceeds to block 211 as described above.

Other embodiments of methods for using a dirty line hint array when flushing a cache are possible within the scope of the present invention. For example, the flush routine may designate the way in the cache and then increment through the applicable sets. In this embodiment, there would be no need to check for a cache hit.

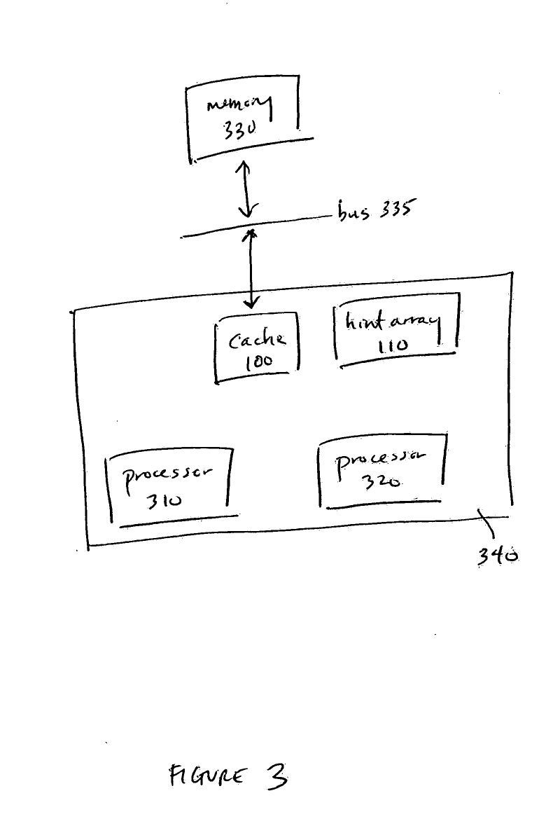

FIG. 3 illustrates an embodiment of a system 300 in which a dirty line hint array may be used when flushing a cache. System 300 includes processors 310 and 320, cache 100 and hint array 110, or any other cache and hint array in accordance with the present invention. Processors 310 and 320 may be any of a variety of different types of processors. For example, the processor may be a general purpose processor such as a processor in the Pentium® Processor Family, the Itanium® Processor Family, or other processor family from Intel Corporation, or another processor from another company.

System 300 also includes memory 330 coupled to cache 100 through bus 335, or through any other buses or components. Memory 330 may be any type of memory capable of storing data to be operated on by processors 310 and 320, such as static or dynamic random access memory, semiconductor-based read only memory, or a magnetic or optical disk memory. The data stored in memory 330 may be cached in cache 100. Memory 330 may also store instructions to implement the cache flush routine of the embodiment of FIG. 2. System 300 may include any other buses or components in addition to processors 310 and 320, cache 100, dirty line hint array 110, memory 330, and bus 335.

Furthermore, any combination of the elements shown in FIG. 3 or any other elements may be implemented together in a single package or on a single silicon die. For example, component 340 may include processors 310 and 320, cache 100, and dirty line hint array 110 on a single silicon die, or a single die of any other material suitable for the fabrication of integrated circuits.

Component 340, or any other component or portion of a component designed according to an embodiment of the present invention, may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these mediums may “carry” or “indicate” the design, or other information used in an embodiment of the present invention, such as the instructions in an error recovery routine. When an electrical carrier wave indicating or carrying the information is transmitted, to the extent that copying, buffering, or re-transmission of the electrical signal is performed, a new copy is made. Thus, the actions of a communication provider or a network provider may be making copies of an article, e.g., a carrier wave, embodying techniques of the present invention.

Thus, techniques for using a dirty line hint array when flushing a cache have been disclosed. While certain embodiments have been described, and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising a plurality of hint bits, where each hint bit corresponds to a plurality of lines in a cache and indicates whether at least one of the plurality of lines is dirty.

2. The apparatus of claim 1, wherein the cache is set associative and each hint bit corresponds to at least one set.

3. A method comprising:
identifying a cache line during a cache flush;
reading a hint bit, where the hint bit corresponds to a plurality of cache lines, including the identified cache line, and indicates whether at least one of the plurality of cache line is dirty;
determining not to write back the identified cache line if the hint bit is clean, without accessing the cache to read the dirty bit corresponding to the identified cache line.

4. The method of claim 3, further comprising accessing the cache to read the dirty bit corresponding to the identified cache line if the hint bit is dirty.

5. The method of claim 4, further comprising:
identifying all of the other cache lines in the plurality of cache lines if the hint bit is dirty;
accessing the cache to read all of the dirty bits corresponding to the other cache lines;
writing back to memory all of the other cache lines for which the corresponding dirty bit is dirty; and
changing the hint bit to clean.

6. A method comprising:
comparing a high order portion of look-up data to a shared high order portion of stored data, where the shared high order portion is shared by a plurality of entry locations in a content addressable memory;
comparing a low order portion of look-up data to a low order portion of each of the plurality of entry locations; and
generating a plurality of hit signals, one for each of the plurality of entry locations, each based on the comparison to the shared high order portion of stored data.

7. A method comprising:
comparing a high order portion of look-up data to a high order portion of a first entry in a content addressable memory;
disabling the logic to compare the high order portion of look-up date to the high order portion of a second entry in the content addressable memory if a prevalidation bit is set;
comparing a low order portion of look-up data to a low order portion of the second entry location; and
generating a hit signal for the second entry location based on the comparison to the high order portion of the first entry and the low order portion of the second entry.

8. A system comprising:
a first processor;
a cache coupled to the first processor; and
a hint array including a plurality of hint bits, where each hint bit corresponds to a plurality of lines in the cache and indicates whether at least one of the plurality of lines is dirty.

9. The system of claim 8 wherein the cache is set associative and each hint bit corresponds to at least one set.

10. The system of claim 8 further comprising a second processor and the cache is shared by the first processor and the second processor.

11. The system of claim 10 wherein the first processor, the second processor, the cache, and the hint array are all on a single die.

12. A system comprising:
a dynamic random access memory;
a cache coupled to the dynamic random access memory;
a processor coupled to the cache; and
a hint array including a plurality of hint bits, where each hint bit corresponds to a plurality of lines in the cache and indicates whether at least one of the plurality of lines is dirty.

13. A machine-readable medium carrying instructions which, when executed by a processor, cause the processor to:
identify a cache line during a cache flush;
read a hint bit, where the hint bit corresponds to a plurality of cache lines, including the identified cache line, and indicates whether at least one of the plurality of cache line is dirty;
determine not to write back the identified cache line if the hint bit is clean, without accessing the cache to read the dirty bit corresponding to the identified cache line.
